(19) United States
(12) Patent Application Publication
(10) Pub. No.: US 2005/0054440 A1
(43) Pub. Date: Mar. 10, 2005

(54) Gaming machine with audio synchronization feature

(75) Inventors: Peter R. Anderson, Chicago, IL (US); Eric M. Pryzby, Skokie, IL (US)

Correspondence Address: Michael J. Blankstein;WMS Gaming, Inc., 3401 N.California Ave., Chicago, IL, 60618, US

(73) Assignee: WMS Gaming Inc.

(21) Appl. No.: 10/832,525

(22) Filed: Apr. 27, 2004

Related U.S. Application Data
(63) Continuation-in-part of application No. 10/658,975, filed on Sep. 10, 2003.

(51) Int. Cl. A63F 13/00

(52) U.S. Cl. 463/30; 463/20

(57) ABSTRACT

A gaming machine for conducting a wagering game includes a sound system for presenting audio directly related to the game or indirectly related as background sound or music. The audio files contain markers that initiate other events and are instrumental in synchronizing the audio to the events.

### REFERENCE TO RELATED APPLICATIONS

This application is a continuation-in-part of U.S. application Ser. No. 10/658,975 entitled “Gaming Machine With Audio Synchronization,” filed Sep. 10, 2003, and incorporated herein by reference in its entirety.

### FIELD OF THE INVENTION

The present invention relates generally to gaming machines and, more particularly, to a gaming machine's audio software containing markers that initiate other events associated with the game.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator. Accordingly, in the competitive gaming machine industry, there is a continuing need for gaming machine manufacturers to produce new types of games, or enhancements to existing games that will attract frequent play by enhancing the entertainment value and excitement associated with the game.

To meet the increasing expectations of players, gaming machines are becoming more sophisticated. New techniques and technologies must be introduced to compete. Some of the new technologies include software driven features such as audio, animation, visual images, and others. The development of these new innovative features can be time consuming.

Visual and audio stimulus provided both to entice game play and to entertain during play are key components in delivering the entertainment experience expected by the player. The combination of video and audio, typically depicted in entertaining animation, is a common feature of many gaming machines. The synchronization of video and audio is a challenge faced by most gaming machine manufacturers. Many man-hours can be spent in timing animation to sound effects and in some cases the timing may not end up quite as precise as desired. This may be noticed by a player and reduce their enjoyment of the game.

One method used to synchronize audio to a visual presentation is to manually add sound to each individual movement (a frame of animation, for example). The animation is completed first and sound added second. A sound engineer must view each frame of animation and add the appropriate sound. This method is time-consuming and requires additional adjustments to increase accuracy.

Mechanical devices, such as puppets with the ability to make mouth movements, also require audio synchronization. As with the issue facing developers of gaming machine video applications, the “matching” of audio sounds to mechanical movement is time-consuming and tedious.

### SUMMARY OF THE INVENTION

In accordance with the foregoing, a gaming machine for conducting a wagering game includes a sound system to play audio sounds directly associated with the game or background sounds. A method for synchronizing events to audio streams is presented. Audio markers are included within audio files to allow the CPU to accurately synchronize audio streams with other events such as animation files, mechanical devices, and lighting.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

The foregoing and other advantages of the invention will become apparent upon reading the following detailed description and upon reference to the drawings in which:

FIG. 1 is a front view of a gaming machine embodying the present invention;

FIG. 2 is a block diagram of a control mechanism used for communication between interface components, a main processor, and display units of the gaming machine;

FIG. 3 is visual representation of a gaming machine's main processor identifying an audio marker, referencing an event response table, and initiating an animation sequence as a result;

FIG. 4 is a flow diagram detailing the process by which an audio marker is identified and responded to; and

FIG. 5 is an example of how audio markers are used to synchronize spoken words with animated mouth movements in an animation sequence.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

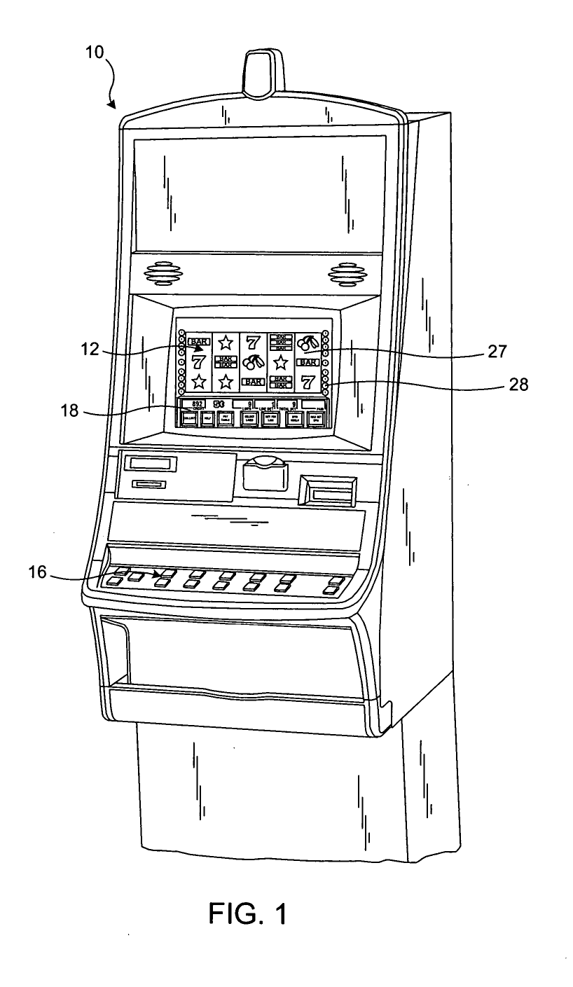

FIG. 1 depicts a gaming machine 10 operable to conduct a slot-based wagering game. In operation, the gaming machine receives a wager from a player to purchase a “play” of the game. In a “play” of the game, the gaming machine generates at least one random event and provides an award to the player for a winning outcome of the random event. The random event may be internally or remotely determined using a random number generator or pooling schema. To portray the random event and outcome to the player, the gaming machine includes a primary display 12. If the wagering game is a reel slot game, for example, the display 12 includes a plurality of symbol-bearing reels 27 that are rotated and stopped to place symbols on the reels in visual association with a number of pay lines 28.

The display 12 may be implemented with a CRT, LCD, plasma, mechanical reels (in the case of a reel slot game), or other type of display known in the art. The display 12, especially if implemented in video, may be overlaid with a touch screen 18 to facilitate interaction with the player. In the illustrated embodiment, the gaming machine 10 is an “upright” version in which the display 12 is oriented vertically relative to the player. Alternatively, the gaming machine may be a “slant-top” version in which the display 12 is slanted at about a thirty-degree angle toward the player of the gaming machine 10.

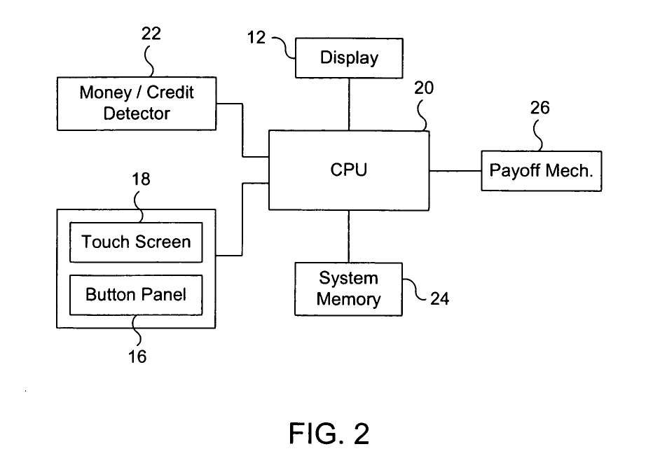

FIG. 2 is a block diagram of a control system suitable for operating the gaming machine. Money/credit detector 22 signals a central processing unit (CPU) 20 when a player has inserted money or played a number of credits. The money may be provided by coins, bills, tickets, coupons, cards, etc. Using a button panel 16 or a touch screen 18 (see FIG. 1), the player may select any variables associated with the wagering game and place his/her wager to purchase a play of the game. In a play of the game, the CPU 20 generates at least one random event using a random number generator (RNG) and provides an award to the player for a winning outcome of the random event. The CPU 20 operates the display 12 to represent the random event(s) and outcome(s) in a visual form that can be understood by the player. In addition to the CPU 20, the control system may include one or more additional slave control units for operating the display 12 and other peripherals such as a secondary display.

System memory 24 stores control software, operational instructions and data associated with the gaming machine. In one embodiment, the system memory 24 comprises a separate read-only memory (ROM) and battery-backed random-access memory (RAM). However, it will be appreciated that the system memory 24 may be implemented on any of several alternative types of memory structures or may be implemented on a single memory structure. A payoff mechanism 26 is operable in response to instructions from the CPU 20 to award a payoff to the player. The payoff may, for example, be in the form of a number of credits. The number of credits is determined by one or more math tables stored in the system memory 24.

Referring to FIG. 1, to play the basic slot game, a player places a wager using the button panel 16 or the touch screen 18. In response to pressing a “spin reels” button, the CPU spins and randomly stops the plurality of symbol-bearing reels 27 on the primary display 12 to place symbols on the reels in visual association with the pay lines 28. Other mechanisms, such as a handle, may be used to set the reels 27 in motion. The number of illustrated reels 27 is five but a different number of reels (e.g., three, four, etc.) may be provided if desired. The number of illustrated pay lines 28 is nine but a different number of pay lines (e.g., five, fifteen, twenty, etc.) may be provided if desired. The display 12 on which the reels are implemented may be mechanical or video. If the display 12 is mechanical, the reels are physical and rotatably driven by stepper motors. If, however, the display 12 is video, the reels are simulated with moving graphics.

The CPU uses a random number generator to select a game outcome (e.g., “basic” game outcome) corresponding to a particular set of reel “stop positions.” The CPU then causes each of the reels to stop at the appropriate stop position. Symbols are displayed on the reels to graphically illustrate the reel stop positions and indicate whether the stop positions of the reels represent a winning game outcome.

Winning basic game outcomes (e.g., symbol combinations resulting in payment of coins or credits) are identifiable to the player by a pay table. The pay table is printed on belly glass, top glass, or may be displayed on the main display 12 or a secondary display, if offered and selected by the player. A winning basic game outcome occurs when the symbols appearing on the reels along an active pay line correspond to one of the winning combinations on the pay table. A winning combination, for example, could be three matching symbols along the pay line, where the award is greater as the number of matching symbols along the pay line increases. If the displayed symbols stop in a winning combination, the game credits the player an amount corresponding to the award in the pay table for that combination multiplied by the number of wagered credits. The player may collect the amount of accumulated credits by pressing a “Collect” key.

Included among the plurality of basic game outcomes is a start-bonus outcome for triggering play of a bonus event. The start-bonus outcome may occur when a special start-bonus symbol or a special combination of symbols appears on one or more of the reels. The appearance of the start-bonus outcome causes the CPU to shift operation from the basic slot game to the bonus event.

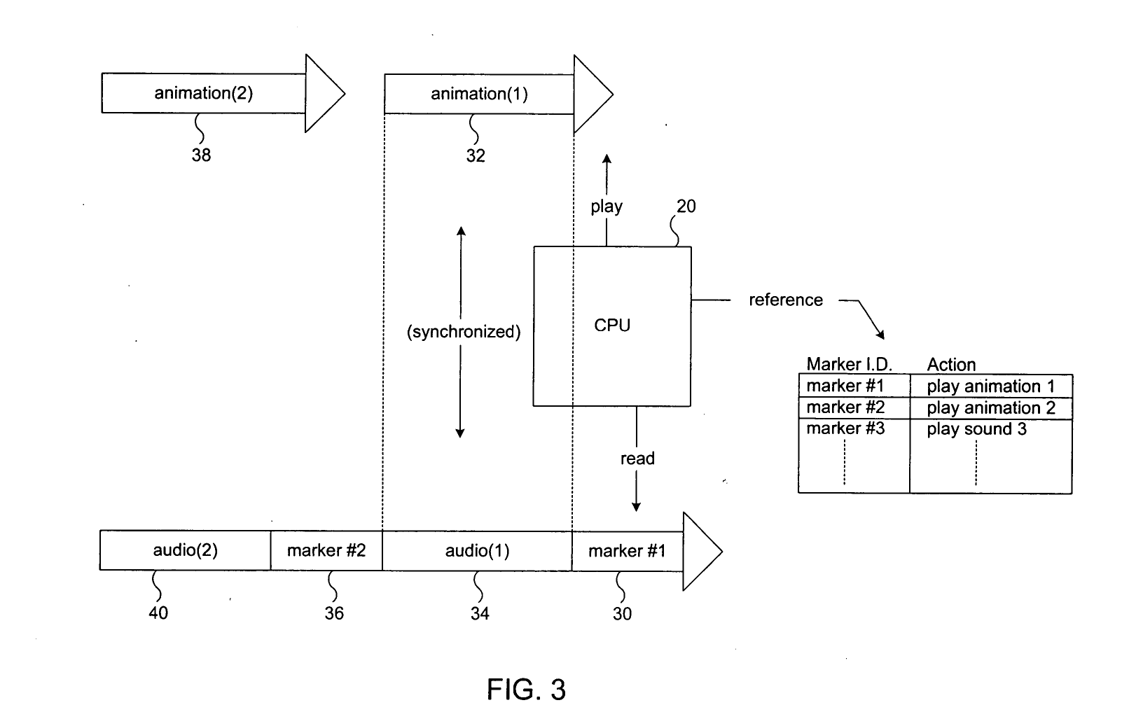

The present invention applies to both the basic game play mode and the bonus round. In many games, especially video-based games, animation and other events are synchronized to the audio played by the gaming machine. The method and technologies used to synchronize the event to the audio stream are similar in many standard audio applications. A marker is embedded in the audio stream and when read by the CPU causes an event to be triggered. FIG. 3 shows the audio stream being played by the CPU 20 and an audio marker 30 being read. The CPU 20 notes the identification number of the marker (1) 30 and references a table or index containing the event to be started. In this example, the CPU reads the identification number (#1) on the marker and retrieves the information specifying that the animation sequence number (1) 32 is to be played. The marker 30 is placed just prior to the audio sequence (1) 34 and as it is played out, the animation sequence (1) 32 is started based on the table or index referenced by the CPU. As the audio stream continues, audio marker (#2) 36 is read by the CPU and, upon checking an event response table or index, the CPU triggers animation sequence (2) 38. This aligns the animation sequence (2) 38 with the audio sequence (2) 40 following the audio marker (#2) 36.

As noted above, tables or indexes are used to store information about audio markers and the events that should be triggered by them. A number of existing audio applications support this technology and method but variations to the method exist in each. One such audio file format is Microsoft Windows-native .wav or Wave file. This file format refers to audio markers as “cue points” and stores the list of cue points in a block of data known as a “chunk”. A specific “cue chunk” is contained in every Wave file and lists the cue points programmed into the audio portion of the file. The cue chunk creates an identification number for each cue point and specifies the cue point's location in the audio stream.

Many different types of events can be initiated by the processing of an audio marker. Some of the events include, but are not limited to playback of another sound file, presentation of a bitmap (.BMP) file, playback of an animation file, activation of a mechanical feature, and initiation of other programming events. Literally any type of event controlled by the CPU in the gaming machine can be initiated when the CPU identifies an audio marker while playing an audio file.

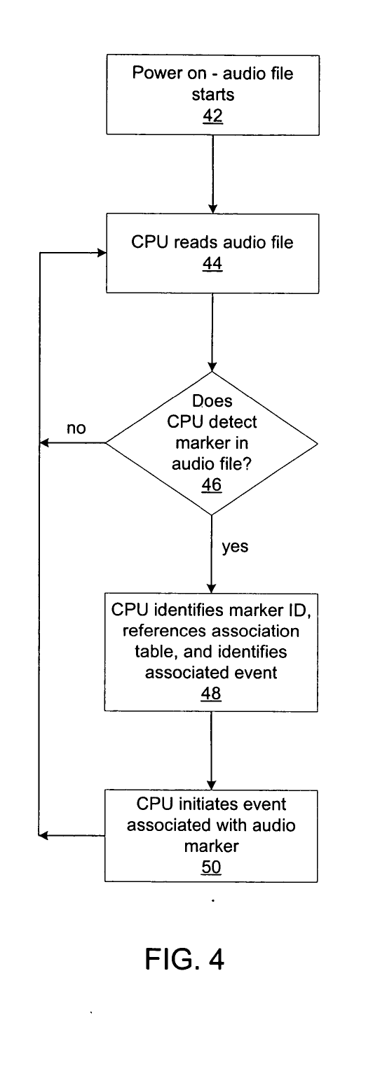

FIG. 4 is a flow diagram showing how the central processing unit (CPU) responds to a marker in an audio file. The initial process shows the gaming machine powering on and the audio file starting at step 42. The CPU plays the audio file and continuously reads it for additional data at step 44. The decision made during the reading of the audio file is whether or not an audio marker is currently present at step 46. If no marker is present, the process is returned to continue the reading of the file at step 44. If an audio marker is present, the CPU determines the marker's identification number (ID), refers to an association table or index, and identifies the event that is to be initiated at step 48. Finally, the CPU initiates the event specified in the table or index at step 50.

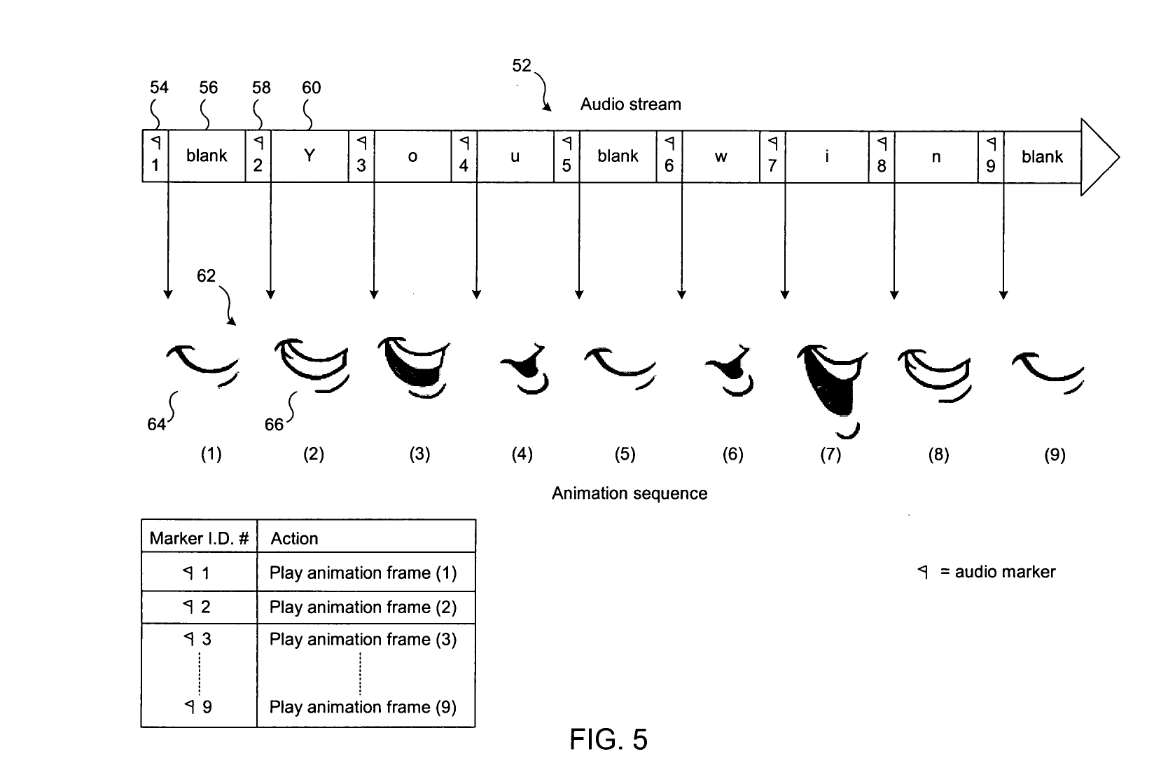

FIG. 5 is a sequential view of an audio/animation stream showing how audio markers synchronize an audio stream to animation frames. In this example, the audio is a voice exclaiming, “You won!” An animated character is visible on a video screen and the character's mouth movements are synchronized to the audio. As an audio stream 52 is played, a marker 54 with an ID of 1 is detected by the CPU. The CPU checks the association table and determines that animation frame (1) 64 is to be played when the audio marker with the ID of 1 is detected. The CPU plays animation frame (1) 64. The audio associated with animation frame (1) 64 immediately follows the audio marker 54. In this example, the audio is silent or blank 56. Following the blank audio 56 is another audio marker 58. The CPU refers to the association table and determines that animation frame (2) 66 is to be played and does so. Animation frame (2) 66 is played simultaneously to the audio following audio marker 58. As is shown in FIG. 5, this sequence of events continues until the audio for this particular sequence is complete.

While the present invention has been described with reference to one or more particular embodiments, those skilled in the art will recognize that many changes may be made thereto without departing from the spirit and scope of the present invention.

For example, another feature that could use audio markers to synchronize with the audio being played by the gaming machine is user selectable closed captioning or subtitles. In the event that a hearing impaired player wants to understand the audio messages gaming machines typically provide players, a user driven menu option could be offered to allow a player to start a closed captioning or subtitles in a selected language on the main display or a secondary display. The menu option may be activated with a touch key on the display. Closed captioning not only provides a hearing impaired player with an understanding of the verbal audio being played by the gaming machine, it also provides sound effects in written text that can enhance the player's gaming experience.

Along the same lines as the closed captioning feature, audio markers can also synchronize the audio stream to animated sign language hand signals. For all verbally delivered information, the gaming machine can offer the hearing impaired player the option of displaying sign language to enhance the gaming experience and to assist in the understanding and play of the game. The option may be activated with a “sign language” touch key on the display. The display could depict the closed captioning, subtitles, or sign language in a small window akin to a picture-in-picture (PIP) window commonly found on larger televisions.

Another alternative is the synchronization of electro-mechanical devices with the audio stream. One aspect of this embodiment is the ability to synchronize movements of electromechanical toys in the top box display area (or other areas) with the audio stream creating a better entertainment experience for the player and reducing the difficulty developing the synchronization. For example, a gaming machine with a puppet character that “speaks” or “sings” during an entertaining portion of a base or bonus game could have its body or mouth movements synchronized to audio cue points embedded within the audio stream played by the gaming machine during certain conditions or situations. Another aspect could have the electro-mechanical reels in a mechanical reel slot game performing to music during a bonus round. The movements of the reels could be directly related to cue points embedded in the audio stream. In an entertaining three-reel mechanical slot machine called “THE WHOLE ENCHILADA”, this method is used to synchronize special music, resultant of a win, to a set electro-mechanical reel movement. This type of audiovisual display helps the player immediately recognize that a significant event has occurred and thus enhances the excitement of the event and likely increases the reaction to it, as well. In “THE WHOLE ENCHILADA”, when a significant event occurs, the game plays a music sequence commonly known as “Mexican Hat Dance”. As the music plays, cue points embedded within the audio stream are processed by the machine's CPU which then signals the electro-mechanical reels to perform a sequence of movements in time with the music resembling a “dance”. While this embodiment refers to the reels as the devices “controlled” by the audio cue points, the movements of other electromechanical and electrical devices can also be triggered. The movements of such devices such as electromechanical “toys” or animatronics can be synchronized to music or audio sequences. For example, if a game has a toy figure with a moveable mouth and one of the game's features is for that figure to “speak” to the player, the synchronization of the audio to the mouth movements can be achieved using audio cue points. The audio cue points in an audio stream can also control other devices such as lighting or moveable marquee displays.

In another embodiment, lighting displays are synchronized to the audio stream in much the same manner as electro-mechanical devices. For example, during an entertaining musical offering, such as the one occurring in “THE WHOLE ENCHLIADA” described previously, the lights switch on and off with the music as well as the reels. Banks of lights or individual lights react to the audio program containing cue points used to trigger the lighting during a particular sequence.

Audio cue points contained in the audio stream can define the behavior of the devices such as lighting and electro-mechanical reels or toys. For example, during basic game play, the behavior of the lighting and mechanical devices would perform in a normal fashion based on a prewritten script. When a special event is triggered, a bonus game for example, a new audio sequence is triggered containing cue points that initiate other devices and components (lighting and electro-mechanical device behavior) and continue to trigger varying behaviors based on the designer's desired presentation. As in other aspects of this invention, the speed and relative ease incorporating cue points into audio streams make this synchronization technique an advantageous choice during gaming machine development.

Each of these embodiments and obvious variations thereof is contemplated as falling within the spirit and scope of the claimed invention, which is set forth in the following claims.

1. A gaming machine for conducting a wagering game, comprising:
a mechanical feature selected from a group consisting of reels and an animatronic figure;
a memory structure for storing an audio file associated with the wagering game, the audio file including a marker and an audio sequence; and
a controller operative to play the audio sequence and initiate movement of the mechanical feature in response to detecting the marker, the movement being pre-associated with the marker.

2. The machine of claim 1, wherein the memory structure includes an association table having the marker and the event associated with the marker, the controller referring to the association table to identify the event to be initiated in response to detecting the marker.

3. The machine of claim 1, wherein the event is selected from a group consisting of playback of another sound file, presentation of a bitmap (.BMP) file, playback of an animation file, and activation of a mechanical feature.

4. The machine of claim 1, wherein the event includes an animation sequence involving movements of a character's mouth.

5. The machine of claim 1, wherein the audio file is formatted as a wave (.wav) file, the marker being an audio cue point embedded within the wave file.

6. A gaming machine for conducting a wagering game, comprising:
a memory structure for storing an audio file associated with the wagering game, the audio file including a plurality of markers and a plurality of audio sequence interlaced between the markers; and
a controller operative to successively play the audio sequences and initiate game-related events pre-associated with the respective audio sequences in response to detecting the respective markers.

7. The machine of claim 6, wherein the memory structure includes an association table having the markers and the events associated with the respective markers, the controller referring to the association table to identify the events to be initiated in response to detecting the respective markers.

8. The machine of claim 6, wherein each event is selected from a group consisting of playback of another sound file, presentation of a bitmap (.BMP) file, playback of an animation file, and activation of a mechanical feature.

9. The machine of claim 6, wherein at least one of the events includes an animation sequence involving movements of a character's mouth.

10. A method of conducting a wagering game, comprising:
storing an audio file associated with the wagering game in a memory structure, the audio file including a marker and an audio sequence; and
playing the audio sequence and initiating a game-related event in response to detecting the marker, the event being pre-associated with the marker.

11. The method of claim 10, wherein the memory structure includes an association table having the marker and the event associated with the marker, and further including referring to the association table to identify the event to be initiated in response to detecting the marker.

12. The method of claim 10, wherein the event is selected from a group consisting of playback of another sound file, presentation of a bitmap (.BMP) file, playback of an animation file, and activation of a mechanical feature.

13. The method of claim 10, wherein the event includes an animation sequence involving movements of a character's mouth.

14. The method of claim 10, wherein the audio file is formatted as a wave (.wav) file, the marker being an audio cue point embedded within the wave file.

15. A method of conducting a wagering game, comprising:
storing an audio file associated with the wagering game in a memory structure, the audio file including a plurality of markers and a plurality of audio sequence interlaced between the markers; and
successively playing the audio sequences and initiating game-related events pre-associated with the respective audio sequences in response to detecting the respective markers.

16. The method of claim 15, wherein the memory structure includes an association table having the markers and the events associated with the respective markers, and further including referring to the association table to identify the events to be initiated in response to detecting the respective markers.

17. The method of claim 15, wherein each event is selected from a group consisting of playback of another sound file, presentation of a bitmap (.BMP) file, playback of an animation file, and activation of a mechanical feature.

18. The method of claim 15, wherein at least one of the events includes an animation sequence involving movements of a character's mouth.

19. A gaming machine for conducting a wagering game, comprising:
a memory structure for storing an audio file associated with the wagering game, the audio file including a marker and an audio sequence;
a controller operative to play the audio sequence and initiate a game-related lighting event in response to detecting the marker, the lighting event being pre-associated with the marker; and
a light source for presenting the lighting event.

20. The machine of claim 19, wherein the memory structure includes an association table having the marker and the lighting event associated with the marker, the controller referring to the association table to identify the lighting event to be initiated in response to detecting the marker.

21. The machine of claim 19, wherein the lighting event is a predetermined command sequence for controlling the light source.

22. The machine of claim 19, wherein the light source is selected from a group consisting of incandescent, fluorescent, LEDs, and cold cathode fluorescent lamp.

23. The machine of claim 19, wherein the audio file is formatted as a wave (.wav) file, the marker being an audio cue point embedded within the wave file.

24. A gaming machine for conducting a wagering game, comprising:
a memory structure for storing an audio file associated with the wagering game, the audio file including a plurality of markers and a plurality of audio sequence interlaced between the markers;
a controller operative to successively play the audio sequences and initiate game-related lighting events pre-associated with the respective audio sequences in response to detecting the respective markers; and
one or more light sources for presenting the lighting events.

25. The machine of claim 24, wherein the memory structure includes an association table having the markers and the lighting events associated with the respective markers, the controller referring to the association table to identify the lighting events to be initiated in response to detecting the respective markers.

26. The machine of claim 24, wherein each lighting event is a predetermined command sequence for controlling the one or more light sources.

27. The machine of claim 24, wherein each light source is selected from a group consisting of incandescent, fluorescent, LEDs, and cold cathode fluorescent lamp.

28. A method of conducting a wagering game, comprising:
storing an audio file associated with the wagering game in a memory structure, the audio file including a marker and an audio sequence; and
playing the audio sequence and initiating a game-related lighting event in response to detecting the marker, the lighting event being pre-associated with the marker.

29. The method of claim 28, wherein the memory structure includes an association table having the marker and the lighting event associated with the marker, and further including referring to the association table to identify the lighting event to be initiated in response to detecting the marker.

30. The method of claim 28, wherein the lighting event is a predetermined command sequence for controlling a light source.

31. The method of claim 28, wherein the audio file is formatted as a wave (.wav) file, the marker being an audio cue point embedded within the wave file.

32. A method of conducting a wagering game, comprising:
storing an audio file associated with the wagering game in a memory structure, the audio file including a plurality of markers and a plurality of audio sequences interlaced between the markers; and
successively playing the audio sequences and initiating game-related lighting events pre-associated with the respective audio sequences in response to detecting the respective markers.

33. The method of claim 32, wherein the memory structure includes an association table having the markers and the lighting events associated with the respective markers, and further including referring to the association table to identify the lighting events to be initiated in response to detecting the respective markers.

34. The method of claim 32, wherein each lighting event is a predetermined command sequence for controlling a light source.
